(19) United States
(12) Patent Application Publication
(10) Pub. No.: US 2021/0117892 A1
(43) Pub. Date: Apr. 22, 2021

(54) INFORMATION PROCESSING APPARATUS, RECORDING MEDIUM, AND INFORMATION PROCESSING METHOD

(71) Applicant: TOYOTA JIDOSHA KABUSHIKI KAISHA, Toyota-shi (JP)

(72) Inventors: Yuki NAKANO, Nisshin-shi (JP); Masato URA, Nisshin-shi (JP); Koji TAKAO, Toyota-shi (JP); Hideyuki SAKURAI, Toyota-shi (JP); Keisuke HOTTA, Miyoshi-shi (JP); Rieko MASUTANI, Toyota-shi (JP); Atsushi HANAWA, Miyoshi-shi (JP); Masanobu OHMI, Kasugai-shi (JP); Takashi HAYASHI, Nagoya-shi (JP); Tetsuro SAKAGUCHI, Toyota-shi (JP); Atsushi NABATA, Nagakute-shi (JP)

(73) Assignee: TOYOTA JIDOSHA KABUSHIKI KAISHA, Toyota-shi (JP)

(21) Appl. No.: 17/071,450

(22) Filed: Oct. 15, 2020

(30) Foreign Application Priority Data
Oct. 18, 2019 (JP) 2019-191045

(51) Int. Cl. G06Q 10/06; G06Q 30/06; G06Q 50/30

(52) U.S. Cl. CPC G06Q 10/06315; B60P 1/6418; G06Q 50/30; G06Q 30/0645

(57) ABSTRACT

Provided is the information processing apparatus that includes a processor configured to: when a rental request for a traveling unit that forms a vehicle by connecting to a body unit and information regarding a destination of move by the vehicle are received from a user terminal, acquire a route to the destination; when a road included in the route to the destination is a first road having a predetermined characteristic, determine a first traveling unit having a performance corresponding to the characteristic of the first road from a plurality of traveling units; and transmit information regarding the route to the destination and information regarding the first traveling unit to the user terminal.

### CROSS REFERENCE TO RELATED APPLICATION

This application claims the benefit of Japanese Patent Application No. 2019-191045, filed on Oct. 18, 2019, which is hereby incorporated by reference herein in its entirety.

### BACKGROUND

### Technical Field

The present disclosure relates to an information processing apparatus, a recording medium, and an information processing method.

### Description of the Related Art

There has been disclosed a changeable vehicle capable of attaching selected body groups (for example, see Patent document 1). By using assembly points for attaching the body groups to the body structure in common for each of changeable vehicles, increase in the manufacture cost is suppressed since there is no need to provide a plurality of patterns of assembly points.

### CITATION LIST

### Patent Document

Patent document 1: Japanese Patent Laid-Open No. 2015-077949

However, when a vehicle actually travels, there is a suitable traveling unit or an unsuitable traveling unit depending on the road condition to be traveled. For example, on mountain roads and snowy roads, a traveling unit of four-wheel drive system can travel more stably than that of two-wheel drive system. For example, in urban districts where there are many narrow roads, a traveling unit capable of making sharper turns can travel stably. Therefore, in order to achieve more stable traveling, changing the body groups might be considered insufficient. Note that the traveling unit means a structural component related to traveling of the vehicle.

An aspect of the disclosure is to provide an information processing apparatus, a recording medium, and an information processing method capable of allowing a vehicle that can exchange its traveling unit to achieve stable traveling.

### SUMMARY

An aspect of the present disclosure is an information processing apparatus, comprising a processor configured to:

acquire, when a rental request for a traveling unit that forms a vehicle by connecting to a body unit and information regarding a destination of move by the vehicle are received from a user terminal, a route to the destination;

determine, when a road included in the route to the destination is a first road having a predetermined characteristic, a first traveling unit having a performance corresponding to the characteristic of the first road from a plurality of traveling units; and

transmit information regarding the route to the destination and information regarding the first traveling unit to the user terminal.

Another aspect of the present disclosure is a recording medium recorded with a program, the program causing a computer to:

transmit, to a predetermined server, a rental request for a traveling unit that forms a vehicle by connecting to a body unit and information regarding a destination of move by the vehicle;

receive, from the predetermined server, information regarding the route to the destination and, when a road included in the route to the destination is a first road having a predetermined characteristic, information regarding a first traveling unit having a performance corresponding to the characteristic of the first road; and

output the information regarding the route to the destination and the information regarding the first traveling unit to a display apparatus.

Another aspect of the present disclosure is an information processing method comprising:

acquiring, when a rental request for a traveling unit that forms a vehicle by connecting to a body unit and information regarding a destination of move by the vehicle are received from a user terminal, a route to the destination;

determining, when a road included in the route to the destination is a first road having a predetermined characteristic, a first traveling unit having a performance corresponding to the characteristic of the first road from a plurality of traveling units; and

transmitting information regarding the route to the destination and information regarding the first traveling unit to the user terminal.

According to the present disclosure, it is possible to allow the vehicle that can exchange the traveling unit to achieve stable traveling.

### BRIEF DESCRIPTION OF DRAWINGS

FIG. 1 is a diagram illustrating an example of a system configuration of a traveling-unit rental system according to a first embodiment;

FIG. 2 is a diagram illustrating an example of a separable vehicle;

FIG. 3 is a diagram illustrating an example of a hardware configuration of the traveling unit;

FIG. 4 is a diagram illustrating an example of a hardware configuration of the center server according to the first embodiment;

FIG. 5 is a diagram illustrating an example of functional configurations of the center server and the user terminal in the traveling-unit rental system;

FIG. 6 is an example of a traveling unit information table. The traveling unit information table is a table held in the traveling unit information database of the center server;

FIG. 7 is an example of a road information table;

FIG. 8 is an example of a flowchart of traveling-unit offering processing of the center server;

FIG. 9 is an example of a flowchart of the offering traveling-unit determining processing of the center server;

FIG. 10 is a diagram illustrating an example of a screen of the user terminal for offering the routes and the traveling units;

FIG. 11 is an example of a flowchart of the offering traveling-unit determining processing of the center server according to the second embodiment; and

FIG. 12 is a diagram illustrating an example of a screen of the user terminal according to the second embodiment for offering the routes and the traveling units.

### DESCRIPTION OF THE EMBODIMENTS

An aspect of the present disclosure is an information processing apparatus that includes a processor configured to: when a rental request for a traveling unit that forms a vehicle by connecting to a body unit and information regarding a destination of move by the vehicle are received from a user terminal, acquire a route to the destination; when a road included in the route to the destination is a first road having a predetermined characteristic, determine a first traveling unit having a performance corresponding to the characteristic of the first road from a plurality of traveling units; and transmit information regarding the route to the destination and information regarding the first traveling unit to the user terminal.

For example, the vehicle is a separable vehicle with which the body unit and the traveling unit can be separated and connected. For example, the traveling unit may be an electric vehicle with an electrically-driven motor loaded thereon or a gasoline-powered vehicle with a gasoline-driven engine loaded thereon. The predetermined characteristic of a road may be being an expressway, a bad road, a narrow road, or the like, for example. Examples of the bad road may be a mountain road, a snowy road, or the like. For example, the first traveling unit having the performance corresponding to the characteristic of the road may be a traveling unit capable of traveling on an expressway, a four-wheel drive traveling unit, a traveling unit whose minimum turn radius is less than a prescribed value, or the like. The information regarding the first traveling unit includes, for example, information regarding the performance of the first traveling unit, information regarding the rental fee, and the like.

According to the aspect of the present disclosure, the information regarding the first traveling unit corresponding to the route to the destination is transmitted to the user terminal that is the source of the rental request for the traveling unit. Thereby, the user of the user terminal can move by using the traveling unit corresponding to the route to the destination, so that it is possible to move with more stable traveling. Further, with the separable vehicle, it is difficult for a single user to own a plurality of traveling units financially and in terms of the space for keeping the traveling units. However, according to the aspect of the present disclosure, it is possible to rent the traveling unit corresponding to the route to the destination, so that the user having the body unit does not need to own a plurality of traveling units of different performances.

In an aspect of the present disclosure, the processor may determine the first traveling unit corresponding to the predetermined characteristic for a first section that includes at least the road having the predetermined characteristic among a plurality of sections divided based on characteristics of roads included in the route to the destination; and transmit, to the user terminal, the information regarding the route to the destination and the information regarding the first traveling unit at least for the first section. The longer the distance of the route to the destination, the more the probability of having the roads of different characteristics included on the route. According to the aspect of the present disclosure, it is possible to travel with exchange with the first traveling unit corresponding to the characteristic in the section of the predetermined characteristic, so that more stable traveling can be achieved.

In an aspect of the present disclosure, the processor may further transmit, to the user terminal, information regarding an exchange place of the traveling unit existing near a start point and an end point of the first section. For example, the exchange place of the traveling units is provided at service stations of the provider company of the traveling units, tollgates of expressways, gasoline stations, near entrances of mountains, and the like. By providing the information regarding the exchange places of the traveling units to the user terminal, it becomes more convenient to make moving plans in advance.

In an aspect of the present disclosure, the processor may: acquire a plurality of routes to the destination; and determine the first traveling unit for each of the plurality of routes to the destination. If the route is different even though the destination is the same, it is highly probable that the characteristics of the roads on the routes are different so that the suitable traveling units are also different. Therefore, according to the aspect of the present disclosure, it is possible to provide more options to the users who are to rent the traveling units and to help to determine the traveling unit to rent.

In an aspect of the present disclosure, the processor may determine a traveling unit capable of traveling on an expressway as the first traveling unit, when a road having a characteristic of being expressway as the predetermined characteristic is included in the route to the destination. The traveling unit capable of traveling on the expressway may be a traveling unit whose motor output is equal to or more than a predetermined value, for example. The traveling unit classified into the so-called minicar, for example, is not allowed to travel on the expressways by law. According to the aspect of the present disclosure, when an expressway is included on the route to the destination, the information regarding the traveling unit capable of traveling on the expressway is transmitted to the user terminal to be offered to the user. This makes it possible to help select the traveling unit corresponding to the route to the destination.

In an aspect of the present disclosure, the processor may determine a four-wheel drive traveling unit as the first traveling unit, when a road having a characteristic of being bad road as the predetermine characteristic is included in the route to the destination. For example, a bad road is a road that is not flat, muddy, and the like so that it is difficult to travel. Specifically, the bad road may be a snowy road, a mountain road, or the like. According to the aspect of the present disclosure, when a bad road is included on the route to the destination, the information regarding the four-wheel drive traveling unit is transmitted to the user terminal to be offered to the user. This makes it possible to help select the traveling unit corresponding to the route to the destination.

In an aspect of the present disclosure, the processor may determine a traveling unit whose minimum turn radius is less than a predetermined value as the first traveling unit, when a road having a characteristic of being narrow road as the predetermined characteristic is included in the route to the destination. The traveling unit whose minimum turn radius is less than a predetermined value is so-called the traveling unit capable of making sharp turns. According to the aspect of the present disclosure, when a narrow road is included on the route to the destination, the information regarding the traveling unit capable of making sharp turns is transmitted to the user terminal to be offered to the user. This makes it possible to help select the traveling unit corresponding to the route to the destination.

In an aspect of the present disclosure, the plurality of traveling units may be traveling units owned by a plurality of individual users. By using the traveling units owned by the individual users to be rented for other users, more types of traveling units and a larger number of traveling units can be secured as the traveling units to be provided for rental. Further, the individual user who provides the traveling unit for rental can acquire a usage fee for rental by providing the traveling for rental unit while not being used, for example.

Hereinafter, embodiments of the present disclosure will be described based on the accompanying drawings. Configurations of the embodiments described hereinafter are examples, and the present disclosure is not limited to the configurations of the embodiment.

### First Embodiment

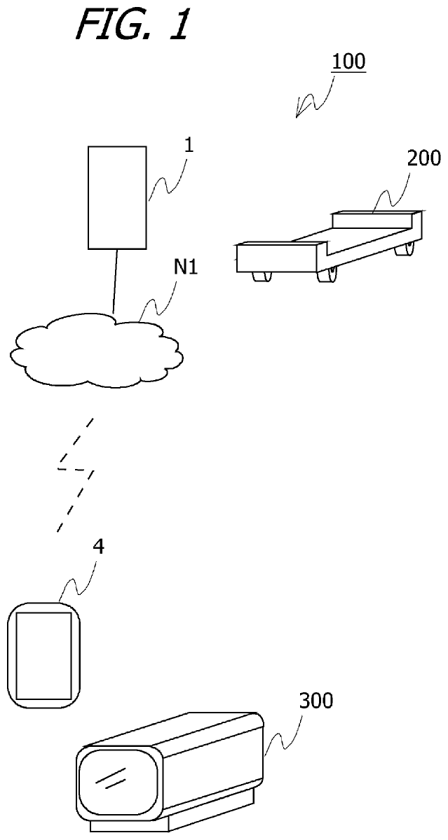

FIG. 1 is a diagram illustrating an example of a system configuration of a traveling-unit rental system 100 according to a first embodiment. The traveling-unit rental system 100 is a system that provides a rental service of traveling units for a vehicle with which the traveling unit and the body unit are separable and connectable, for example. The traveling-unit rental system 100 includes a center server 1 and a user terminal 4, for example.

The center server 1 is a server that manages a plurality of traveling units 200 and controls rental of the traveling units 200. The user terminal 4 is a user terminal of a user who owns a traveling unit and a body unit 300, for example. The user terminal 4 has an application installed therein for using services provided by the traveling-unit rental system 100, for example. While the traveling-unit rental system 100 includes a plurality of user terminals 4, a single user terminal 4 is illustrated in FIG. 1 for simplification.

The center server 1 and the user terminal 4 are connected to a network N1 such as the Internet, for example, and communicable via the network N1. Further, in the first embodiment, the traveling unit 200 has a communication function, and can communicate with the center server 1 via the network N1.

In the first embodiment, when the user oneself owns the traveling unit but thinks that there is more suitable traveling unit for moving to the destination, for example, the user desires to rent a more suitable traveling unit 200. In this case, the user terminal 4, by an operation input of the user, transmits a rental request for the traveling unit 200 and information regarding a departure point and a destination to the center server 1. Upon receiving the rental request for the traveling unit 200 from the user terminal 4, the center server 1 acquires a plurality of routes to the destination.

The center server 1 determines the traveling unit 200 to be offered to the user according to each of the acquired routes. Specifically, the center server 1 determines whether or not a road of a predetermined characteristic is included in the routes and, when the road of the predetermined characteristic is included in the routes, determines to offer the traveling unit 200 that has the performance suited for traveling on the road of the predetermined characteristic. Examples of the characteristic of the road may be being an expressway, a snowy road, a mountain road, a narrow road, and the like. There may be cases where it is difficult with the traveling unit owned by the user, for example, to travel stably on the roads having such characteristics.

The center server 1 transmits information regarding the plurality of routes to the destination and information regarding the traveling units 200 to be offered for each of the routes to the user terminal 4 that is the source of the rental request. The user terminal 4 displays the information received from the center server 1 on a display. The user selects a combination of the route to the destination and the traveling unit 200 to be rented from the plurality of routes and the offered traveling units 200 displayed on the display. The user terminal 4 transmits, to the center server 1, information of the combination of the route and the traveling unit 200 selected by the operation of the user. The center server 1 receives the information from the user terminal 4, and generates a schedule for renting the selected traveling unit 200 to the user. On a start date/time for rental, the center server 1 moves the selected traveling unit 200 to the designated place of the user and rental of the traveling unit 200 is started.

According to the first embodiment, the information regarding the traveling unit 200 corresponding to the route to the destination is transmitted to the user terminal 4, so that the user can stably travel to the destination by using the traveling unit 200 corresponding to the route to the destination. Further, it is not practical for a single user to own a plurality of traveling units 200 financially and in terms of the parking space thereof, but the user does not need to own the plurality of traveling units 200 since the traveling unit 200 corresponding to the route to the destination can be rented.

<Separable Vehicle>

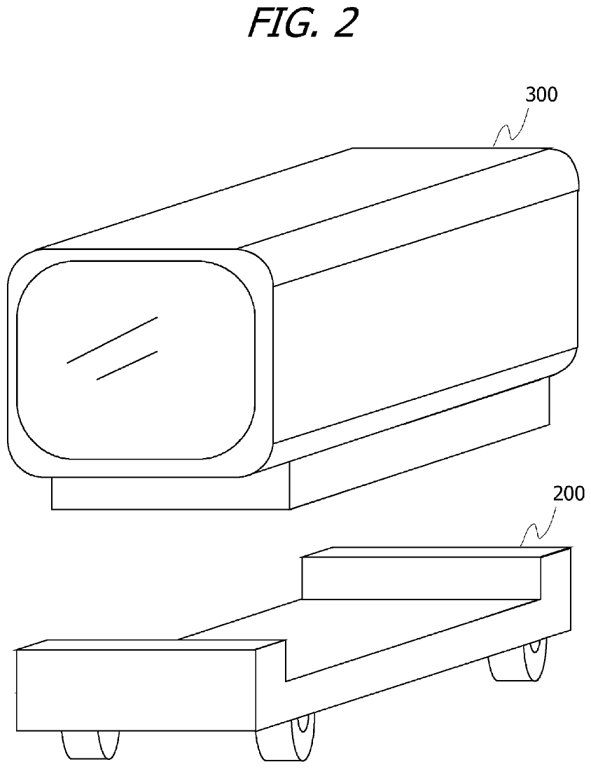

FIG. 2 is a diagram illustrating an example of a separable vehicle. In the first embodiment, it is assumed to use a separable vehicle with which the body unit and the traveling unit can be separated. As the separable vehicle, for example, there is a top-and-bottom separable vehicle in which the body unit 300 is loaded on the traveling unit 200 as illustrated in FIG. 2. However, the separable vehicle is not limited to the top-and-bottom separable vehicle. For example, there may also be a front-and-rear separable vehicle in which a traveling unit is connected to the front of a body unit and travels by towing the body unit. The traveling unit 200 and the body unit 300 are connected by a predetermined method. The connecting method of the traveling unit 200 and the body unit 300 is not limited to a specific method but any of existing techniques may be used. For example, as the connecting method of the traveling unit 200 and the body unit 300, there are a method using a connecting/separating mechanism, a method using an electromagnet, and the like. Further, as a method for loading the body unit 300 onto the traveling unit 200 or bringing down the body unit 300 from the traveling unit 200 with the top-and-bottom separable vehicle, for example, there are a method using a dedicated lift, a method using a mechanism for loading on or bringing down provided to the body unit 300 or the traveling unit 200 itself, and the like. The method for loading the body unit 300 onto the traveling unit 200 or bringing down the body unit 300 from the traveling unit 200 with the top-and-bottom separable vehicle is not limited to a specific method.

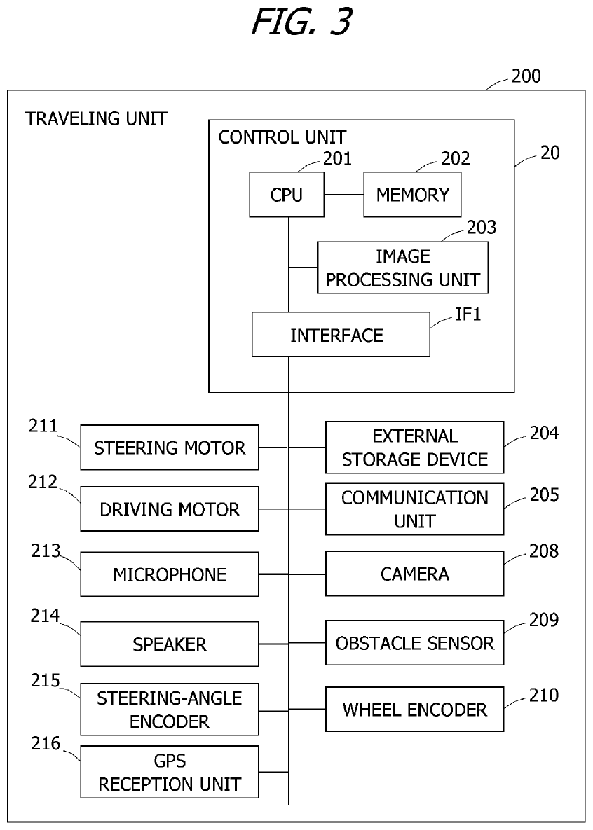

FIG. 3 is a diagram illustrating an example of a hardware configuration of the traveling unit 200. In the first embodiment, the traveling unit 200 is assumed as an autonomous electrically driven vehicle. Therefore, FIG. 3 illustrates a case where it is assumed that the traveling unit 200 is an autonomous electrically driven vehicle. Note that hardware related to a control system of the traveling unit 200 is extracted and illustrated in FIG. 3.

The traveling unit 200 includes a control unit 20, an external storage device 204, a communication unit 205, a camera 208, an obstacle sensor 209, a wheel encoder 210, a steering motor 211, a driving motor 212, a microphone 213, a speaker 214, a steering-angle encoder 215, and a GPS (Global Positioning System) reception unit 216.

The control unit 20 is also referred to as an electronic control unit (ECU). The control unit 20 includes a CPU 201, a memory 202, an image processing unit 203, and an interface IF1. To the interface IF1, the external storage device 204, the communication unit 205, the camera 208, the obstacle sensor 209, the wheel encoder 210, the steering motor 211, the driving motor 212, the microphone 213, the speaker 214, the steering-angle encoder 215, and the GPS reception unit 216 are connected.

The obstacle sensor 209 is an ultrasonic sensor, a radar, or the like. The obstacle sensor 209 emits an ultrasonic wave, an electromagnetic wave, or the like toward a detection-target direction, and detects presence, position, relative speed, and the like of an obstacle in the detection-target direction based on a reflected wave. Examples of the obstacle may be a pedestrian, a bicycle, a structure, and a building. For example, in a case where the traveling unit 200 is in a box shape as illustrated in FIG. 3, a plurality of obstacle sensors 209 are provided, and each of the plurality of obstacle sensors 209 is provided at a position close to four corner areas in the front, rear, left, and right of the traveling unit 200. Note that the front, rear, left, and right of the traveling unit 200 are determined according to the traveling direction, for example.

The camera 208 is an imaging device using an image sensor such as a charged-coupled device (CCD), a metal-oxide-semiconductor (MOS), a complementary-metal-oxide-semiconductor (CMOS) or the like. The camera 208 acquires an image at a predetermined time interval called a frame period, and stores the acquired images in a frame buffer within the control unit 20. A plurality of cameras 208 are provided to the traveling unit 200, and the plurality of cameras 208 are set toward the outer side of the vehicle at each of side faces in the front, rear, left, and right of the traveling unit 200, for example.

The steering motor 211, according to a direction signal from the control unit 20, controls the direction of an intersection line along which the wheel rotation plane intersects with the horizontal plane, that is, the angle to be the traveling direction by rotation of the wheels. The driving motor 212, according to a direction signal from the control unit 20, drives and rotates each of the wheels provided to the traveling unit 200, for example. Note, however, that the driving motor 212 may drive either one out of two pairs of wheels in the front and rear.

The steering-angle encoder 215 detects the steering angle as the traveling direction of the wheels at a predetermined detection time interval, and stores the detected steering angles in a register of the control unit 20. The steering angle is the angle of the rotation axis of the wheels within the horizontal plane. For example, the origin of the angles is set in the direction along which the rotation axis of the wheels is orthogonal to the traveling direction of the traveling unit 200. Further, the wheel encoder 210 acquires the rotation angle of the wheels at a predetermined detection time interval, and stores the acquired rotation angles in a register of the control unit 20.

The communication unit 205 is a communication unit that is connected to a WiFi access point or a mobile-phone base station, for example, and communicates with various kinds of servers and the like on the network via a public communication network connected thereto. The communication unit 205 performs wireless communication with wireless signals and a wireless communication method conforming to a predetermined wireless communication standard.

The GPS reception unit 216 receives radio waves of time signals from a plurality of artificial satellites (Global Positioning Satellites) orbiting the earth, and stores the received time signals in a register of the control unit 20. The microphone 213 detects voices, converts the voices to digital signals, and stores the digital signals to a register of the control unit 20. The speaker 214 is driven by a D/A converter and an amplifier connected to the control unit 20 or a signal processing unit, and reproduces acoustics including sounds and voices.

The CPU 201 of the control unit 20 executes a computer program expanded on the memory 202 to be executable so as to execute processing as the control unit 20. In the memory 202, the computer program executed by the CPU 201, data, and the like to be processed by the CPU 201 are stored. The memory 202 may be a dynamic random access memory (DRAM), a static random access memory (SRAM), a read only memory (ROM), or the like, for example. The image processing unit 203 cooperates with the CPU 201 to process the data in the frame buffer acquired from the camera 208 by every predetermined frame period. The image processing unit 203 includes a GPU and an image memory to be the frame buffer, for example. The external storage device 204 is a nonvolatile storage device, and examples thereof may be a solid state drive (SSD), a hard disk drive, and the like.

For example, the control unit 20 acquires detection signals from sensors of each unit of the traveling unit 200 via the interface IF1. Further, the control unit 20 calculates the latitude and the longitude as the position on the earth based on the detection signals from the GPS reception unit 216. Further, the control unit 20 acquires map data from a map information database stored in the external storage device 204, and collates the calculated latitude and longitude with the position on the map data to determine the current position. Further, the control unit 20 acquires a route from the current position to a destination on the map data. Furthermore, the control unit 20 detects obstacles in the surroundings of the traveling unit 200 based on the signals from the obstacle sensor 209, the camera 208, and the like, determines the traveling direction by avoiding the obstacles, and control the steering angle.

Further, the control unit 20 cooperates with the image processing unit 203 to process the images acquired from the camera 208 by each frame data, and detects a change based on a difference between the images, for example, to recognize an obstacle. Note that the control unit 20 may transmit the frame data of the images from the camera 208 and voice data acquired from the microphone 213 to the center server 1 on the network from the communication unit 205. Then, the frame data of the images and the voice data may be analyzed by the center server 1.

While the interface IF1 is illustrated as an example in FIG. 3, exchange of the signals between the control unit 20 and a control subject is not limited to be done via the interface IF1. That is, the control unit 20 may have a plurality of signal exchanging paths other than the interface IF1. Further, in FIG. 3, the control unit 20 includes the single CPU 201. However, the CPU is not limited to a single processor but may be of a multiprocessor configuration. Further, a single CPU connected via a single socket may have a multicore configuration. At least part of processing of each of the above-described units may be executed by a processor other than the CPU, such as a dedicated processor that may be a digital signal processor (DSP), a graphics processing unit (GPU), or the like, for example. Further, at least part of the processing of each of the above-described units may be operated by an integrated circuit or a digital circuit other than that. Further, an analog circuit may be included at least in part of each of the above-described units.

<Apparatus Configuration>

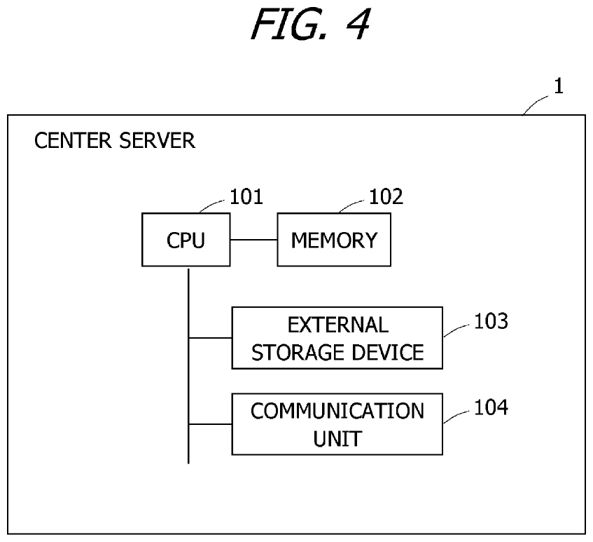

FIG. 4 is a diagram illustrating an example of a hardware configuration of the center server 1 according to the first embodiment. The center server 1 is a dedicated computer or a multi-purpose computer, for example. The center server 1 includes, as the hardware configuration, a CPU (Central Processing Unit) 101, a memory 102, an external storage device 103, and a communication unit 104. The memory 102 and the external storage device 103 are recording media that can be read by the computer. The center server 1 is an example of the “information processing apparatus”.

The external storage device 103 stores various programs and data used by the CPU 101 when executing each of the programs. Examples of the programs held in the external storage device 103 may be an operating system (OS), a control program of the traveling-unit rental system 100, and various other application programs. The control program of the traveling-unit rental system 100 is a program for offering and providing the traveling unit 200 corresponding to the route to the destination for rental in response to the rental request from the user.

The memory 102 is a main memory that provides a storage area and a work area for the CPU 101 to load the programs stored in the external storage device 103, and is used as a buffer. The memory 102 includes a semiconductor memory such as a ROM (Read Only Memory) or a RAM (Random Access Memory), for example.

The CPU 101 has the OS and various application programs held in the external storage device 103 loaded on the memory 102, and executes those to execute various kinds of processing. The CPU 101 is not limited to be one, but a plurality of those may be provided. The CPU 101 is an example of the “processer” of the “information processing apparatus”.

The communication unit 104 is an interface for inputting and outputting information with the network. The communication unit 104 may be an interface connected to a wired network or may be an interface connected to a wireless network. The communication unit 104 is an NIC (Network Interface Card), a wireless circuit, or the like, for example. The communication unit 104 is connected to a LAN (Local Network Area), for example, connected to a public communication network via the LAN, and communicates with various kinds of servers and the user terminal 4 on the network via the public communication network.

Note that the hardware configuration of the center server 1 illustrated in FIG. 4 is an example, and it is not intended to be limited thereto. It is possible to omit, replace, or add structural elements as appropriate according to embodiments. For example, the center server 1 may include a removable recording medium drive, and execute programs recorded in removable recording media. The removable recording medium is a recording medium such as an SD card, mini SD card, a micro SD card, a USB (Universal Serial Bus), a flash memory, a CD (Compact Disk), a DVD (Digital Versatile Disc), a Blu-ray® Disc, or a flash memory card. Further, for example, the center server 1 may include an input apparatus and an output apparatus. The input apparatus is a keyboard, a mouse, a touch panel, or the like, for example. The output apparatus is a display or the like, for example.

Examples of the user terminal 4 may be a smartphone, a tablet terminal, a PC (Personal Computer), a wearable terminal, and the like. The user terminal 4 includes, as the hardware configuration, a touch panel display, a speaker, a microphone, a camera, a GPS reception unit, various kinds of sensors, and the like in addition to a CPU, a memory, an external storage device, and a communication unit.

Note that a series of processing executed by the center server 1 and the user terminal 4 is not limited to be achieved by execution of software by the processor. Such processing can be achieved by hardware such as an FPGA (Field-Programmable Gate Array) or the like, for example.

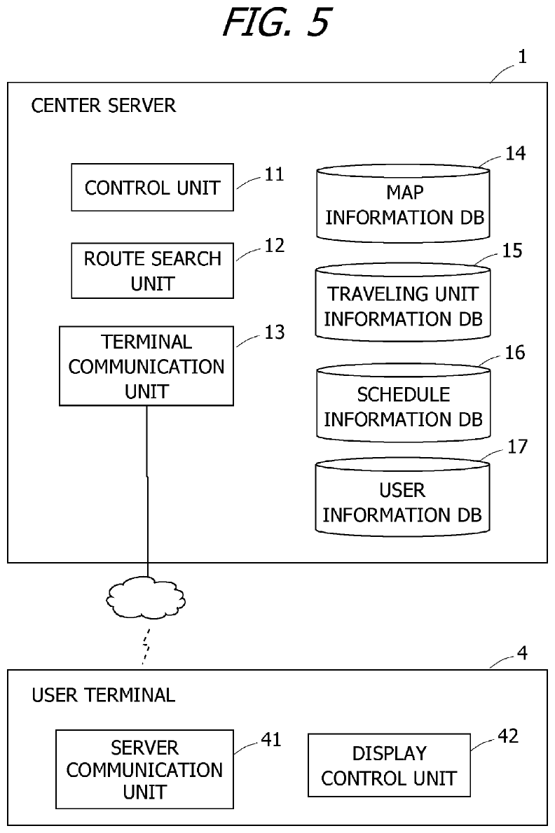

FIG. 5 is a diagram illustrating an example of functional configurations of the center server 1 and the user terminal 4 in the traveling-unit rental system 100. The center server 1 includes, as functional structural elements, a control unit 11, a route search unit 12, a terminal communication unit 13, a map information database (DB) 14, a traveling unit information DB 15, a schedule information DB 16, and a user information DB 17. For example, those functional structural elements are achieved by executing, by the CPU 101 of the center server 1, the control program of the traveling-unit rental system 100 stored in the external storage device 103.

The terminal communication unit 13 is an interface for communicating with the user terminal 4. The communication terminal unit 13 transmits the data inputted from the control unit 11 to the user terminal 4 via the communication unit 104, for example. Further, the terminal communication unit 13 receives the data from the user terminal 4 via the communication unit 104, and outputs the received data to the control unit 11. For example, as the data received from the user terminal 4, there are a rental request for the traveling unit, information regarding the departure point and the destination, information of a combination of the route and the traveling unit 200 selected for the offered route, and the like. Along with the rental request for the traveling unit, for example, information regarding the user, information regarding planned start date/time and planned end date/time for renting the traveling unit 200, and the like are also received. The information regarding the user includes identification information of the user, for example.

The control unit 11 receives, from the terminal communication unit 13, for example, input of the rental request for the traveling unit, the information regarding the departure point and the destination, and the like received from the user terminal 4. In this case, the control unit 11 acquires a predetermined number of routes to the destination by requesting the route search unit 12 to acquire the routes to the destination. The control unit 11 determines whether or not each of the routes to the destination includes the roads having the predetermined characteristics. For the route determined to include the road having the predetermined characteristic, the control unit 11 determines the traveling unit 200 having the performance corresponding to traveling on the road having such characteristic. The control unit 11 transmits, to the user terminal 4 as the source of the rental request, the information regarding the plurality of routes to the destination and the information regarding the traveling units 200 to be offered for each of the routes.

The information regarding the routes includes information regarding the departure point of the routes and the destination, information regarding via points, information of the time for reaching the destination, and the fee charged at a toll road to be passed, for example. The information regarding the traveling unit 200 offered to each of the routes includes the information regarding the performance, information regarding the rental fee, information indicating the appearance, of the corresponding traveling unit 200, and the like. Examples of the information regarding the performance of the traveling unit 200 may be information regarding the drive system, the minimum turn radius, the battery capacity, the rated output of the motor, and the like, and one of or a plurality of those are included.

The control unit 11 receives, from the user terminal 4 via the terminal communication unit 13, input of the information regarding the traveling unit 200 to be rented. The control unit 11 sets, for the corresponding traveling unit 200, a schedule to be rented to the user. On the start date/time for rental, the control unit 11 moves the corresponding traveling unit 200 to a designated place of the user and starts the rental schedule.

The route search unit 12 acquires the route to the destination according to the request from the control unit 11. The route search unit 12 acquires the route to the destination based on the information held in the map information DB 14 to be described later. The method for acquiring the route by the route search unit 12 may be any of existing methods and not limited to any specific method. The route search unit 12 acquires a predetermined number of routes to the destination, and outputs the acquired routes to the control unit 11.

The map information DB 14, the traveling unit information DB 15, the schedule information DB 16, and the user information DB 17 are generated within a storage area of the external storage device 103 of the center server 1, for example. For example, map information for searching the routes, information regarding the roads, and the like are held in the map information DB 14. The information regarding the traveling units is stored in the traveling unit information DB 15. Details of the information stored in the traveling unit information DB 15 will be described later.

For example, information regarding the rental schedule of the traveling units 200 is held in the schedule information DB 16. The information regarding the rental schedule of the traveling unit 200 includes, for example, identification information of the schedule, identification information of the user to rent, identification information of the traveling unit 200 to be rented, planned start date/time and planned end date/time for rental, information regarding the place to which the traveling unit 200 first moves, and the like. The user information DB 17 includes, for example, identification information of the user, information regarding the traveling unit owned by the user, information regarding the body unit owned by the user, and information regarding the payment method and the like designated by the user.

Note that the processing of each of the functional structural elements of the center server 1 illustrated in FIG. 5 may be achieved by a single computer or may be achieved by a plurality of computers in a distributed manner. For example, each of the map information DB 14, the traveling unit information DB 15, the schedule information DB 16, and the user information DB 17 may be held by an external server.

Next, the user terminal 4 includes a server communication unit 41 and a display control unit 42 as functional structural elements. Those functional structural elements are achieved by executing, by the CPU of the user terminal 4, the program that is stored in the external storage device for receiving the services of the traveling-unit rental system 100, for example.

The server communication unit 41 is an interface for communicating with the center server 1. The server communication unit 41 transmits the data inputted from the display control unit 42 to the center server 1 via the communication unit, for example. Further, the server communication unit 41 receives the data from the center server 1 via the communication unit, and outputs the received data to the display control unit 42. For example, the data transmitted to the center server 1 from the user terminal 4 may be a rental request for the traveling unit, the information regarding the departure point and the destination, the information regarding the combination of the route and the traveling unit 200 selected from the offered routes, and the like. For example, the data received from the center server 1 may be the information regarding the route to the destination and the information regarding the offered traveling unit 200.

The display control unit 42 controls input and output of a touch panel display of the user terminal 4. Specifically, the display control unit 42, based on the user operation inputted from the touch panel display, outputs the rental request for the traveling unit, the information regarding the departure point and the destination, and the like to the server communication unit 41 to transmit to the center server 1. Further, the display control unit 42 outputs, on the touch panel display from the server communication unit 41 according to a predetermined screen format, the information regarding the route to the destination and the information regarding the offered traveling unit 200 received from the center server 1.

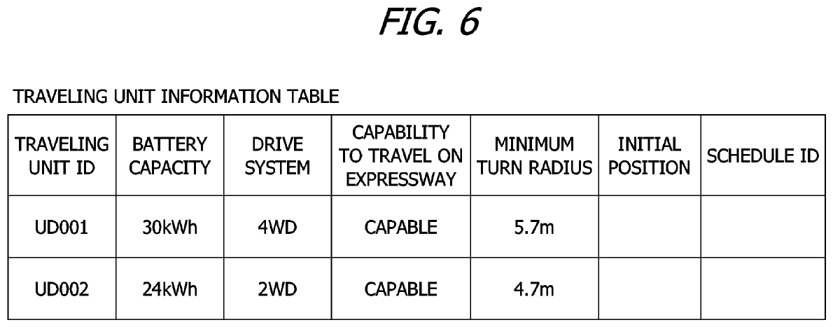

FIG. 6 is an example of a traveling unit information table. The traveling unit information table is a table held in the traveling unit information DB 15 of the center server 1. In the traveling unit information table, the information regarding the traveling units 200 managed by the center server 1 is stored. The traveling unit information table illustrated in FIG. 6 includes fields of traveling unit ID, battery capacity, drive system, capability to travel on expressway, minimum turn radius, initial position, and schedule ID.

In the field of the traveling unit ID, the identification information of the traveling unit 200 is stored. In the field of the battery capacity, the battery capacity of the traveling unit 200 is stored. In the field of the drive system, the information indicating the drive system of the traveling unit 200 is stored. The information indicating the drive system of the traveling unit 200 may be a code or a flag, for example. Examples of the drive system of the traveling unit 200 may be four-wheel drive, two-wheel drive, and the like. However, the drive systems of the traveling units 200 are not limited to those. In FIG. 6, “4WD” is written in the field of the drive system in a case of the four-wheel drive traveling unit 200. In a case of the two-wheel drive traveling unit 200, “2WD” is written in the field of the drive system.

In the field of the capability to travel on expressway, the information indicating whether or not the traveling unit 200 is capable of traveling on the expressway is stored. Whether or not the traveling unit 200 is capable of traveling on the expressway is based on the rated output of the motor of the traveling unit 200 and/or the size or the like of the traveling unit 200, for example.

In the field of the minimum turn radius, the minimum turn radius of the traveling unit 200 is stored. The minimum turn radius is one of indicators indicating the sharp turn performance of the traveling unit 200. Note that the indicator indicating the sharp turn performance of the traveling unit 200 is not limited to the minimum turn radius. For example, other indicators indicating the sharp turn performance of the traveling unit 200 may be the size of the tires, the length of the wheelbase, and the like.

In the field of the initial position, information of the initial position of the traveling unit 200 is stored. The initial position of the traveling unit 200 is also referred to as a return place or a standby place of the traveling unit 200, for example. In the field of the schedule ID, identification information of the schedule allotted to the traveling unit 200 is stored.

The values in the fields of the traveling unit ID, the battery capacity, the drive system, the capability to travel on expressway, the minimum turn radius, and the initial position are inputted in advance by the administrator of the center server 1. The value in the field of the schedule ID is updated by the control unit 11 when a schedule is set for the corresponding traveling unit 200, for example. Note that the information stored in the traveling unit information table is not limited to those illustrated in FIG. 6.

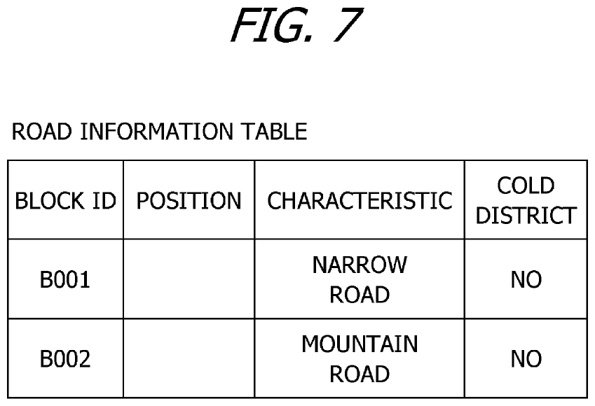

FIG. 7 is an example of a road information table. The road information table is a table held in the map information DB 14 of the center server 1. The road information table is the table that holds the information regarding the roads. In the example illustrated in FIG. 7, information of the characteristics of the roads included in each of blocks divided in a subject area is stored. The block is set by dividing the subject area into a mesh form.

The road information table illustrated in FIG. 7 includes fields of block ID, position, characteristic, and cold district. In the field of the block ID, identification information of the block is stored. In the field of the position, positional information of the corresponding block is stored.

In the field of the characteristic, information indicating the characteristic of the road included in the block is stored. In the field of the characteristic, for example, the characteristic of the road occupying the highest proportion among the roads included in the block is stored. As the characteristics of the roads indicated in the field of the characteristic, there may be types such as an expressway, a mountain road, a narrow road, and the like, for example. Those may be expressed by a code or a flag, for example. Note, however, terms indicating the characteristics of the roads are stored in the field of the characteristic in the example illustrated in FIG. 7 for convenience.

In the field of the cold district, stored is the information indicating whether or not the area of the block is the cold district. The information indicating whether or not it is the cold district is a code or a flag, for example. However, in the example illustrated in FIG. 7, however, “YES” or “NO” is used for convenience as the information indicating whether or not it is the cold district. In the area of the block that is the cold district, it is highly probable to have the roads covered with snow in winter, for example. Therefore, it is treated as an area including a snowy road.

The road information table is referred when determining the traveling unit 200 corresponding to the route to the destination, for example. In a case where the route to the destination passes the block having the characteristic of being expressway, for example, the traveling unit 200 capable of traveling on the expressway is selected. In a case where the route to the destination passes the block having the characteristic of being mountain road, for example, the four-wheel drive traveling unit 200 is selected. Note that the information included in the road information table is not limited to those illustrated in FIG. 7.

<Flow of Processing>

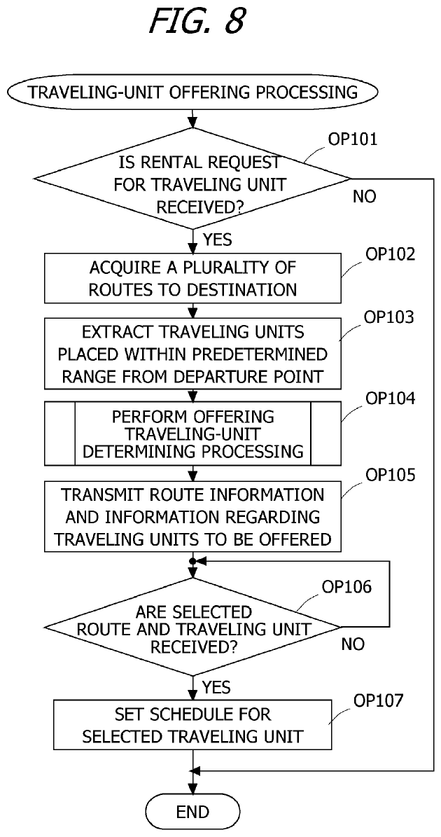

FIG. 8 is an example of a flowchart of traveling-unit offering processing of the center server 1. The traveling-unit offering processing is the processing for offering, to the user, the traveling unit 200 corresponding to the route to the destination. The processing illustrated in FIG. 8 is repeatedly executed in a predetermined period. While the execution subject of the processing illustrated in FIG. 8 is the CPU 101 of the center server 1, the functional structural element is described as the main subject for convenience.

In OP101, the control unit 11 determines whether or not a rental request for the traveling unit is received from the user terminal 4. When the rental request for the traveling unit is received from the user terminal 4 (OP101: YES), the processing proceeds to OP102. When the rental request for the traveling unit is not received from the user terminal 4 (OP101: NO), the processing illustrated in FIG. 8 is ended. Along with the rental request, the information regarding the user, the information regarding the departure point and the destination, the information regarding the planned start and end date/time for rental, and the like are also received.

In OP102, the control unit 11 request the route search unit 12 to acquire a predetermined number of routes to the destination. In OP103, the control unit 11 extracts the traveling units 200 placed within a predetermined range from the departure point based on the traveling unit information DB 15. For example, the predetermined range from the departure point may be set by the distance or may be set by the traveling time.

In OP104, the control unit 11 performs offering traveling-unit determining processing. The offering traveling-unit determining processing is the processing for determining the traveling units 200 to be offered for each of the routes acquired in OP102. Details of the offering traveling-unit determining processing will be described later.

In OP105, the control unit 11 transmits, to the user terminal 4, the information of the routes to the destination and the information regarding the traveling units 200 to be offered for each of the routes. In OP106, the control unit 11 determines whether or not a selection result of the route and the traveling unit 200 is received from the user terminal 4. When the selection result of the route and the traveling unit 200 is received from the user terminal 4 (OP106: YES), the processing proceeds to OP107. When the selection result of the route and the traveling unit 200 is not received from the user terminal 4 (OP106: NO), the processing of OP106 is repeated.

In OP107, the control unit 11 sets the schedule for the selected traveling unit 200. Thereby, the schedule information DB 16 is updated. Thereafter, the processing illustrated in FIG. 8 is ended.

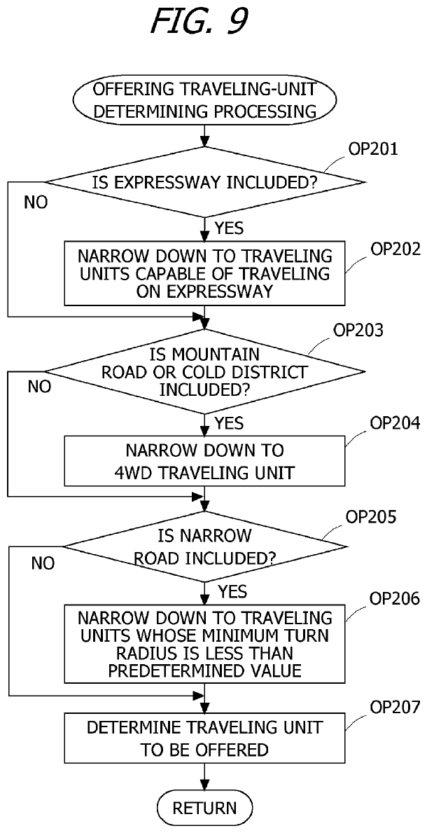

FIG. 9 is an example of a flowchart of the offering traveling-unit determining processing of the center server 1. The processing illustrated in FIG. 9 is the processing executed in OP104 of the traveling-unit offering processing of FIG. 8. The processing illustrated in FIG. 9 is executed for each of the routes acquired in OP102 of FIG. 8. In FIG. 9, the route to be the subject of the processing is referred to as a subject route.

In OP201, the control unit 11 determines whether or not the subject route includes an expressway. For example, when a block having “expressway” written in the field of the characteristic of the road information table is included in the blocks the subject route passes through, it is determined positive in OP201. When the subject route includes the expressway (OP201: YES), the processing proceeds to OP202. When the subject route does not include any expressway (OP201: NO), the processing proceeds to OP203. In OP202, the control unit 11 narrows down the subject traveling units 200 to the traveling units 200 that can travel on the expressway. The subject traveling units 200 are the traveling units 200 extracted in OP103 of FIG. 8, for example.

In OP203, the control unit 11 11 determines whether or not the subject route includes a mountain road or a cold district. For example, when a block having “mountain road” written in the field of the characteristic of the road information table is included in the blocks the subject route passes through or when it is currently winter and a block having “YES” written in the field of the cold district is included, it is determined positive in OP203. When the subject route includes the mountain road or the cold district (OP203: YES), the processing proceeds to OP204. When the subject route does not include the mountain road nor the cold district (OP203: NO), the processing proceeds to OP205. In OP204, the control unit 11 further narrows down to the four-wheel drive traveling units 200.

In OP205, the control unit 11 determines whether or not the subject route includes a narrow road. For example, when a block having “narrow road” written in the field of the characteristic of the road information table is included in the blocks the subject route passes through, it is determined positive in OP205. When the subject route includes the narrow road (OP205: YES), the processing proceeds to OP206. When the subject route does not include the narrow road (OP205: NO), the processing proceeds to OP207. In OP206, the control unit 11 further narrows down to the traveling units 200 whose minimum turn radius is less than a predetermined value.

In OP207, the control unit 11 decides the traveling unit 200 to be offered for the subject route among the narrowed-down traveling units 200. The traveling unit 200 to be offered for the subject route may be randomly selected from the traveling units 200 that have no schedule set during the time from the planned start date/time for rental to the planned end date/time for rental, or may be selected according to a predetermined criterion. When the subject route does not include any of the expressway, mountain road, cold district, and narrow road, the control unit 11 may not determine the traveling unit 200 to be offered or may offer the traveling unit 200 owned by the user. If the user does not own the traveling unit 200, it is possible to select the traveling unit 200 to be offered randomly or select the one whose rental fee is the lowest among the subject traveling units 200. Thereafter, the processing proceeds to the processing of FIG. 9 for the next route or OP105 of FIG. 8.

According to the offering traveling-unit determining processing illustrated in FIG. 9, when the subject route includes an expressway and a mountain road, for example, the four-wheel drive traveling unit 200 that is capable of traveling on the expressway is selected. When the subject route includes an expressway and a narrow road, for example, the traveling unit 200 that is capable of traveling on the expressway and whose minimum turn radius is less than a predetermined value is selected. For example, it is also possible to put the priority according to the characteristics of the roads, and select the traveling unit 200 corresponding to the characteristic of the highest priority. For example, in a case where the characteristics of the roads is defined as mountain road or cold district>expressway>narrow road, the four-wheel drive traveling unit 200 may be selected when the subject route passes a mountain road and a narrow road. Note that the traveling-unit offering processing and the offering traveling-unit determining processing are not limited to those illustrated in FIG. 8 and FIG. 9.

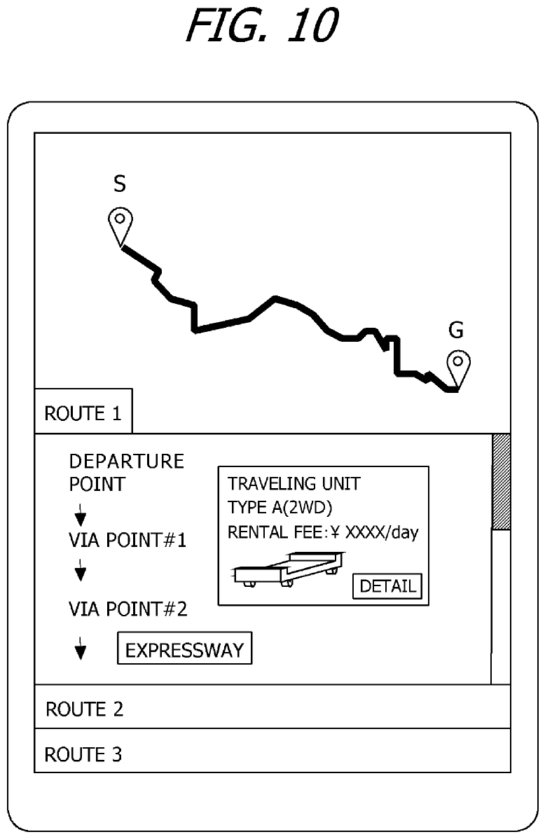

FIG. 10 is a diagram illustrating an example of a screen of the user terminal 4 for offering the routes and the traveling units. On the screen of the user terminal 4 for offering the routes and the traveling units, the information regarding a plurality of routes received from the center server 1 and information regarding the traveling units 200 offered for each of the routes are displayed. In addition to the departure point and the destination, information regarding via points may also be displayed as the information regarding the routes. Examples of the via points may be an intersection at which the traveling unit makes right turn or left turn and an access or exit of a toll road and the like. Further, as the information regarding the traveling unit 200 to be offered, information regarding the type, the rental fee, the appearance, of the traveling unit 200 and the like may also be displayed.

### Advantages and Effects of First Embodiment

In the first embodiment, the center server 1 selects the traveling unit 200 according to the characteristic of the road the route to the destination passes, and offers it to the user. Thereby, the user who rents the traveling unit 200 can move and travel stably by using the traveling unit 200 corresponding to the characteristic of the road on the route to the destination.

Further, in the first embodiment, it is assumed to rent the traveling unit of the separable vehicle with which the body unit and the traveling unit can be separated. Therefore, by using the own body unit, the user can move with the vehicle interior environment that is same as usual even when the traveling unit 200 is changed. Further, the user can use the traveling unit 200 having the corresponding performance when needed even if the user does not own a plurality of traveling units 200 corresponding to each of the plurality of characteristics of the road. Thereby, individuals can suppress increase in the cost for owning and using the separable vehicles.

### Second Embodiment

In a second embodiment, the center server 1 divides the route to the destination into sections according to the characteristics of the roads, and determines and offers the traveling units 200 corresponding to the characteristics of the roads included in each of the sections and exchange places of the traveling units 200. Thereby, in the second embodiment, the user who rents the traveling unit 200 moves to the destination while exchanging the traveling unit 200 at a designated exchange place. In the second embodiment, explanations of those in common to the first embodiment are omitted.

In the second embodiment, the system configuration of the traveling-unit rental system 100 and the hardware configurations as well as the functional configurations of the center server 1 and the user terminal 4 are the same as those of the first embodiment. Further, in the second embodiment, the traveling-unit offering processing of the center server 1 is also the same as that of the first embodiment.

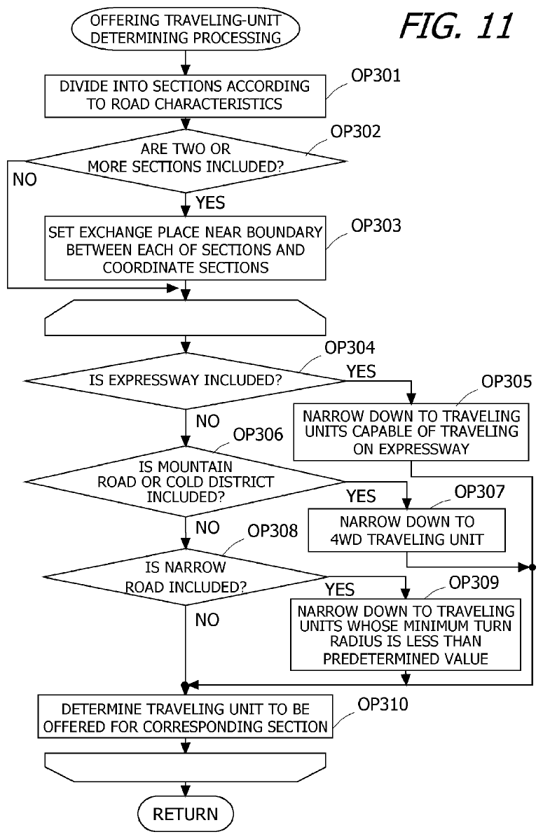

FIG. 11 is an example of a flowchart of the offering traveling-unit determining processing of the center server 1 according to the second embodiment. The processing illustrated in FIG. 11 in the second embodiment is the processing executed in OP104 of the traveling-unit offering processing in FIG. 8. The processing illustrated in FIG. 11 is executed for each of the routes acquired in OP102 of FIG. 8, for example. In FIG. 11, the route to be the subject of the processing is referred to as a subject route.

In OP301, the control unit 11 divides the subject route into sections according to the characteristics of the roads. For example, on the subject route, a boundary point between blocks of different characteristics of the roads is the boundary point of the sections.

In OP302, the control unit 11 determines whether or not the subject route includes two or more sections. When the subject route includes two or more sections (OP302: YES), the processing proceeds to OP303. When the subject route does not include two or more sections (OP302: NO), the processing proceeds to OP304.

In OP303, the control unit 11 sets an exchange place near the boundary between the sections on the subject route and coordinates the boundary between the sections. For example, the exchange place may be a service station owned by the provider of the traveling unit 200. In the service station, for example, a plurality of traveling units 200 and facilities and the like needed for exchanging the traveling units 200 are provided. For example, such service station is placed along arterial roads, near tollgates of expressways, near entrances and exits of mountain roads, and the like. After setting the exchange place of the traveling unit 200, the control unit 11 revises the setting of the sections such that the exchange place comes at the boundary between the sections.

Then, the processing from OP304 to OP310 is executed for each of the sections of the subject route. Hereinafter, the section that is the subject of the processing is referred to as a subject section.

In OP304, the control unit 11 determines whether or not the subject section includes an expressway. For example, when the subject section includes a block having “expressway” written in the field of the characteristic of the road information table, it is determined positive in OP304. When the subject section includes an expressway (OP304: YES), the processing proceeds to OP305. When the subject section does not include any expressway (OP304: NO), the processing proceeds to OP306.

In OP305, the control unit 11 narrows down the subject traveling units 200 into the traveling units 200 that can travel on the expressway. The subject traveling units 200 are the traveling units 200 extracted in OP103 of FIG. 8, for example.

In OP306, the control unit 11 determines whether or not the subject section includes a mountain road or a cold district. For example, when the subject section includes a block having “mountain road” written in the field of the characteristic of the road information table or when it is currently winter and a block having “YES” written in the field of the cold district is included, it is determined positive in OP306. When the subject section includes the mountain road or the cold district (OP306: YES), the processing proceeds to OP307. When the subject section does not include the mountain road nor the cold district (OP306: NO), the processing proceeds to OP308. In OP307, the control unit 11 further narrows down the subject traveling units 200 to the four-wheel drive traveling units 200. The subject traveling units 200 are the traveling units 200 extracted in OP103 of FIG. 8, for example.

In OP308, the control unit 11 determines whether or not the subject section includes a narrow road. For example, when the subject section includes a block having “narrow road” written in the field of the characteristic of the road information table, it is determined positive in OP308. When the subject section includes the narrow road (OP308: YES), the processing proceeds to OP309. When the subject route does not include the narrow road (OP308: NO), the processing proceeds to OP310. In OP309, the control unit 11 further narrows down the subject traveling units 200 to the traveling units 200 whose minimum turn radius is less than a predetermined value. The subject traveling units 200 are the traveling units 200 extracted in OP103 of FIG. 8, for example.

In OP310, the control unit 11 determines the traveling unit 200 to be offered for the subject section among the narrowed-down traveling units 200. The traveling unit 200 to be offered for the subject section may be randomly selected from the traveling units 200 that have no schedule set during the time from the planned start date/time for rental to the planned end date/time, or may be selected according to a predetermined criterion. When the subject section does not include any of the expressway, mountain road, cold district, and narrow road, the traveling unit 200 may not be offered or the use of the traveling unit 200 owned by the user may be offered. If the user does not own the traveling unit 200, it is possible to select the traveling unit 200 to be offered randomly or select the one whose rental fee is the lowest among the subject traveling units 200. Thereafter, the processing proceeds for the next section, next route, or OP105 of FIG. 8.

According to the offering traveling-unit determining processing illustrated in FIG. 11, when the subject route includes a section of the mountain road, for example, the four-wheel drive traveling unit 200 is selected for the section of the mountain road, and the traveling unit 200 owned by the user or the two-wheel drive traveling unit 200 is selected for other sections. When the user rents the traveling unit 200 as offered, the user exchanges the own traveling unit 200 with the four-wheel drive traveling unit 200 at the exchange place near the entrance of the mountain road, for example, and exchanges the four-wheel drive traveling unit 200 with the two-wheel drive traveling unit 200 at the exchange place near the exit of the mountain road. That is, in the second embodiment, when there are a plurality of sections included in a single route, a plurality of traveling units 200 are offered according to the characteristics of the roads included in each of the sections.

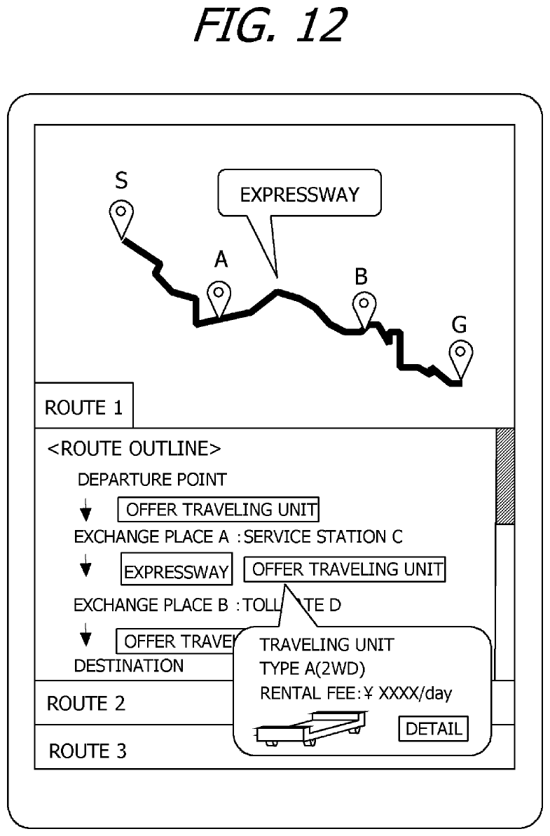

FIG. 12 is a diagram illustrating an example of a screen of the user terminal 4 according to the second embodiment for offering the routes and the traveling units. In the second embodiment, the traveling unit 200 is offered for each of the sections, so that the sections on the route and the traveling units 200 offered for each of the sections are displayed on the screen for offering. In the example illustrated in FIG. 12, information regarding the currently selected route among a plurality of routes offered by the center server 1 is displayed. Further, for the section having a predetermined characteristic on the route, information indicating the characteristic is displayed. When a button “offer traveling unit” accompanying each of the sections is selected, information regarding the traveling unit 200 offered for the corresponding section is popup-displayed.

When the traveling unit 200 owned by the user is used on the route and exchanged with another traveling unit 200 somewhere on the way, the center server 1 may suggest a return route to stop by at the exchange place where the traveling unit 200 owned by the user was exchanged so as to exchange back to the traveling unit 200. Further, the center server 1 may give an instruction to the traveling unit 200 owned by the user to move to a predetermined exchange place on a return route. Note that the configuration of the screen for offering the routes and the traveling units is not limited to the one illustrated in FIG. 12.

### Advantages and Effects of Second Embodiment

In the second embodiment, the route to the destination is divided into sections according to the characteristics of the roads, and the traveling unit 200 is offered according to the characteristic of the road for each section. By renting the traveling unit 200 based on the offer, it is possible to move by using the traveling unit 200 corresponding to the characteristic of the road in each of the sections. Therefore, it is possible to provide more stable traveling throughout the entire route.

Further, in the second embodiment, assumed is the separable vehicle with which the body unit and the traveling unit are separated. Therefore, there is no exchange of the body unit even in a case of move by exchanging the traveling unit 200 between each of the sections, so that it is possible to move without changing the vehicle interior environment.

### Other Embodiments

The embodiment described above is an example, and the present disclosure may be changed and carried out as appropriate without departing from the gist of the present disclosure.

While the expressway, bad road, and narrow road are presented as the characteristics of the roads in the embodiments described above, the characteristics of the roads are not limited to those. Further, in determining the traveling unit 200 to be offered, it is also possible to take the influences of the volatile weather, disasters, accidents, and the like into consideration in addition to the characteristics of the roads.

In the embodiments described above, it is assumed that the traveling units 200 to be rented are the traveling units 200 owned by the manager of the center server 1. However, the traveling units 200 to be rented are not limited to those but may be the traveling units 200 owned by individual users. When using the traveling unit 200 owned by the individual user as the traveling unit 200 to be rented, the user registers, to the center server 1, the information regarding the traveling unit 200 to be provided to the traveling-unit rental system 100. For example, as the information regarding the traveling unit 200 to be registered to the center server 1, there are the car type of the traveling unit 200, schedule information, initial position, and the like. When the traveling units 200 owned by the individual users are provided as the traveling units 200 for rental, the system side can secure more types and a larger number of traveling units 200 to be provided for rental. Meanwhile, the individual user who provides the traveling unit 200 for rental can acquire a rental fee by providing the traveling unit 200 for rental while not being used.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus, comprising a processor configured to:
acquire, when a rental request for a traveling unit that forms a vehicle by connecting to a body unit and information regarding a destination of move by the vehicle are received from a user terminal, a route to the destination;
determine, when a road included in the route to the destination is a first road having a predetermined characteristic, a first traveling unit having a performance corresponding to the characteristic of the first road from a plurality of traveling units; and
transmit information regarding the route to the destination and information regarding the first traveling unit to the user terminal.

2. The information processing apparatus according to claim 1, wherein the processor is configured to:
determine the first traveling unit corresponding to the predetermined characteristic for a first section that includes at least the road having the predetermined characteristic among a plurality of sections divided according to characteristics of roads included in the route to the destination; and
transmit, to the user terminal, the information regarding the route to the destination and the information regarding the first traveling unit at least for the first section.

3. The information processing apparatus according to claim 2, wherein the processor is further configured to transmit, to the user terminal, information regarding an exchange place of the traveling unit existing near a start point and an end point of the first section.

4. The information processing apparatus according to claim 1, wherein the processor is configured to:
acquire a plurality of routes to the destination; and
determine the first traveling unit for each of the plurality of routes to the destination.

5. The information processing apparatus according to claim 1, wherein the processor is configured to determine a traveling unit capable of traveling on an expressway as the first traveling unit, when a road having a characteristic of being expressway as the predetermined characteristic is included in the route to the destination.

6. The information processing apparatus according to claim 1, wherein the processor is configured to determine a four-wheel drive traveling unit as the first traveling unit, when a road having a characteristic of being bad road as the predetermined characteristic is included in the route to the destination.

7. The information processing apparatus according to claim 1, wherein the processor is configured to determine a traveling unit whose minimum turn radius is less than a predetermined value as the first traveling unit, when a road having a characteristic of being narrow road as the predetermined characteristic is included in the route to the destination.

8. The information processing apparatus according to claim 1, wherein the plurality of traveling units are traveling units owned by a plurality of individual users.

9. A non-transitory computer-readable recording medium recorded with a program, the program causing a computer to:
transmit, to a predetermined server, a rental request for a traveling unit that forms a vehicle by connecting to a body unit and information regarding a destination of move by the vehicle;
receive, from the predetermined server, information regarding the route to the destination and, when a road included in the route to the destination is a first road having a predetermined characteristic, information regarding a first traveling unit having a performance corresponding to the characteristic of the first road; and
output the information regarding the route to the destination and the information regarding the first traveling unit to a display apparatus.

10. The non-transitory computer-readable recording medium according to claim 9, wherein the program causes the computer to receive, from the predetermined server, information regarding the first traveling unit determined according to the predetermined characteristic for a first section that includes at least the road having the predetermined characteristic among a plurality of sections divided according to characteristics of roads included in the route to the destination.

11. The non-transitory computer-readable recording medium according to claim 10, wherein the program further causes the computer to transmit, to the user terminal, information regarding an exchange place of the traveling unit existing near a start point and an end point of the first section.

12. The non-transitory computer-readable recording medium according to claim 9, wherein the program causes the computer to receive and display, on the display apparatus, information regarding a plurality of routes to the destination and information regarding the first traveling unit for each of the plurality of routes to the destination.

13. An information processing method comprising:
acquiring, when a rental request for a traveling unit that forms a vehicle by connecting to a body unit and information regarding a destination of move by the vehicle are received from a user terminal, a route to the destination;
determining, when a road included in the route to the destination is a first road having a predetermined characteristic, a first traveling unit having a performance corresponding to the characteristic of the first road from a plurality of traveling units; and
transmitting information regarding the route to the destination and information regarding the first traveling unit to the user terminal.

14. The information processing method according to claim 13, wherein
the determining is configured to determine the first traveling unit corresponding to the predetermined characteristic for a first section that includes at least the road having the predetermined characteristic among a plurality of sections divided according to characteristics of roads included in the route to the destination; and
the transmitting is configured to transmit, to the user terminal, the information regarding the route to the destination and the information regarding the first traveling unit at least for the first section.

15. The information processing method according to claim 14, further comprising transmitting, to the user terminal, information regarding an exchange place of the traveling unit existing near a start point and an end point of the first section.

16. The information processing method according to claim 13, comprising:
acquiring a plurality of routes to the destination; and
determining the first traveling unit for each of the plurality of routes to the destination.

17. The information processing method according to claim 13, wherein the determining is configured to determine a traveling unit capable of traveling on an expressway as the first traveling unit, when a road having a characteristic of being expressway as the predetermined characteristic is included in the route to the destination.

18. The information processing method according to claim 13, wherein the determining is configured to determine a four-wheel drive traveling unit as the first traveling unit, when a road having a characteristic of being bad road as the predetermined characteristic is included in the route to the destination.

19. The information processing method according to claim 13, wherein the determining is configured to determine a traveling unit whose minimum turn radius is less than a predetermined value as the first traveling unit, when a road having a characteristic of being narrow road as the predetermined characteristic is included in the route to the destination.

20. The information processing method according to claim 13, wherein the plurality of traveling units are traveling units owned by a plurality of individual users.
